(19) United States
(12) Patent Application Publication
(10) Pub. No.: US 2015/0317083 A1
(43) Pub. Date: Nov. 5, 2015

(54) Synergetic deduplication

(71) Applicants: Lan Dinh Phan, Trabuco Canyon, CA (US); Virtium Technology, Inc., Rancho Santa Margarita, CA (US)

(72) Inventor: Lan Dinh Phan, Trabuco Canyon, CA (US)

(73) Assignees: Virtium Technology, Inc., Rancho Santa Margarita, CA (US); Lan Dinh Phan, Trabuco Canyon, CA (US)

(21) Appl. No.: 14/269,203

(22) Filed: May 5, 2014

(51) Int. Cl. G06F 3/06

(52) U.S. Cl. CPC G06F 3/0608; G06F 3/0641; G06F 3/0679

(57) ABSTRACT

Flash memory devices can be implemented with deduplication mechanism through a synergetic deduplication mapping that combines the logical-to-physical address mapping of the flash memory devices with the deduplication mapping. A deduplication algorithm can be implemented in the application layer, which can freely communicate with the flash memory devices and perform computationally expensive operations.

### BACKGROUND The present invention generally relates to deduplication methods in storage devices, and in particular to storage devices using flash memories as a storage medium.

Random access nonvolatile storage media such as magnetic disks have been used as the data storage media. For example, re-writable high capacity storage devices include hard disk drives.

In recent years, various erasable nonvolatile semiconductor memory devices have been developed, called solid state drives, which include flash memory devices. Solid state drives can be low cost, low power consumption, and fast access time.

Deduplication technology has been used for increasing storage capacity of storage devices. Deduplication technology has been applied to solid state devices to reduce data rewriting counts, which can potentially increase the life span of the solid state drives.

There is a need for an improved deduplication methodology for solid state drives.

### SUMMARY OF THE EMBODIMENTS

In some embodiments, the present invention discloses methods and systems for storage devices, such as flash memory devices, having deduplication features. The mapping in the flash memory devices, e.g., a logical-to-physical address mapping, can be configured to function as a deduplication mapping, allowing the memory arrays of the flash memory devices to hold data without duplications.

In some embodiments, the present invention discloses synergetic deduplication process for storage devices. The software layer, e.g., the flash translation layer, can combine the deduplication mapping of the data with the logical-to-physical address mapping of the storage devices. With both mappings managed at this layer, the storage devices can have reduced overhead, such as reducing the requirement of a separate deduplication management mechanism within the storage devices.

In some embodiments, the deduplication algorithm can be implemented in the application layer, which can freely communicate with the storage device and perform computationally expensive operations.

### BRIEF DESCRIPTION OF THE DRAWINGS

FIGS. 1A-1C illustrate a solid state drive and its operation according some embodiments.

FIGS. 2A-2B illustrate schematics of a deduplication mechanism according to some embodiments.

FIG. 3 illustrates a solid state drive having an integrated or synergetic deduplication mapping according to some embodiments.

FIG. 4 illustrates a schematic of an integrated deduplication flash translation layer mapping according to some embodiments.

FIGS. 5A-5B illustrate concepts of synergetic deduplication mapping according to some embodiments.

FIGS. 6A-6B illustrate flowcharts for forming solid state drives having synergetic deduplication mapping according to some embodiments.

FIGS. 7A-7C illustrate flow charts for forming mapping table in a solid state drive according to some embodiments.

FIGS. 8A-8B illustrate flow charts for methods to store data in a solid state drive with deduplication feature according to some embodiments.

FIG. 9 illustrates a flow chart for methods to store data in a solid state drive with deduplication feature according to some embodiments.

FIG. 10 illustrates a flow chart for methods to store data in a solid state drive with deduplication feature according to some embodiments.

FIG. 11 illustrates a flow chart for methods to read data in a solid state drive with deduplication feature according to some embodiments.

FIG. 12 illustrates a system for synergetic deduplication according to some embodiments.

FIG. 13 illustrates a flow chart for storing data from a host system to a solid state drive according to some embodiments.

FIG. 14 illustrates a system for synergetic deduplication according to some embodiments.

FIG. 15 illustrates a flow chart for storing data from a host system to a solid state drive according to some embodiments.

FIG. 16 illustrates a computing environment according to some embodiments.

FIG. 17 is a schematic block diagram of a sample computing environment with which the present invention can interact.

### DETAILED DESCRIPTION OF THE EMBODIMENTS

In some embodiments, the present invention discloses methods, systems, and devices having the methods implemented, for implementing deduplication in storage devices, such as flash memory devices which are commonly called solid state drives or solid state disks. The logical-to-physical address translation or mapping, e.g., the translation or mapping of logical block addresses in application software to physical addresses in the flash memory devices, can be modified so that the mapping can also include deduplication mapping, e.g., the translation or mapping of addresses of duplicated data blocks to same physical addresses.

In flash memory devices, a software program can be implemented in a flash translation layer (FTL) to perform logical-to-physical address translation or mapping, for example, to hide the erase-before-write characteristics and the excessive latency of block erases of the flash memory devices. The logical-to-physical address mapping is operable to translate a logical address of the data block to a physical address in flash memory. The logical address is typically an arbitrary pointer to the data block, while the physical address is typically the pointer to the memory location in which the data block is stored. For example, the logical addresses can be virtual addresses corresponded to common data storages such as hard drives, viewed by an operating system.

In some embodiments, the present invention discloses deduplication logical-to-physical address mappings. In a deduplication logical-to-physical address mapping, the logical addresses of multiple identical blocks, e.g., the duplicated blocks, can be mapped to a same physical address, thus the data is deduplicated in the storage devices, e.g., duplicated blocks are stored only once in the physical memory. For example, the deduplication logical-to-physical address mapping can be a multiple-to-one mapping, in contrast to an one-to-one mapping of traditional logical-to-physical address mapping.

In some embodiments, the deduplication logical-to-physical address mapping can include a synergy between the mapping from logical addresses to physical addresses needed for flash memory device, together with the mapping from logical addresses of different but identical data blocks to same physical addresses needed for deduplication implementation. The synergetic involvement of the storage devices in the implementation of deduplication process, e.g., the logical-to-physical mapping that also functions as a deduplication mapping, can reduce the overhead related to deduplication mechanism, such as a deduplication mapping managements in the software layer.

Additionally, the synergetic mapping can allow the data stored in the storage devices to be independently deduplicated. This is in contrast to separate mappings, in which the separated deduplication mapping requires that the deduplication map must be loaded to access the deduplication feature. The synergetic cooperation of application and storage device mechanisms to perform deduplication can thus provide significant advantages over separate deduplication mapping methodology.

In some embodiments, the present invention discloses storage devices with deduplication features, and methods and systems to implement the storage devices. The storage devices can include solid state devices which have flash memory packages connected to a controller.

Solid state devices utilize solid state memory arrays, thus there are no mechanical moving parts, leading to potential higher reliability. In addition, the memory arrays can be configured to allow parallel processing, leading to potential faster access time.

The solid state memory arrays can include flash memory devices, which differ from other forms of memory storage since the flash memory devices cannot be overwritten without first being erased. Further, the flash memory devices have limited re-writing cycles, thus wear leveling is typically implemented, in which the usage of the flash memory devices are uniformly spread around the solid state drives.

For example, block-level wear leveling can be used by a controller of the flash memory devices to track the erase and write status of various memory blocks. New blocks can be allocated for use to accommodate newly received data, evenly distributing the usage of memory blocks.

To hide the differences of the solid state drives, e.g., the high erase overhead, a memory access abstraction can be implemented, for example, in the flash translation layer. A logical-to-physical address mapping can represent the physical addresses of the flash memory devices with logical addresses, e.g., logical addresses of traditional hard drives, to the application software.

Operations of a flash memory are explained below. A block in a flash memory is a memory unit for collectively erasing data. A page is a memory unit for reading and writing data. A block can have multiple pages. A word is a memory unit for data modification. A page can have multiple words. The flash memory cannot directly rewrite data. The memory will need to be erased before new data can be rewritten at that memory. Thus, in a typical operation, when a new data needs to be rewrite to a word in a block of the flash memory, the stored valid old data in the block is saved, e.g., written, to another block. The old data in the block are erased, and then the new data is written to the erased block.

Thus the rewriting of data in a flash memory necessitates the erasure of data per block, which can severely affect the rewriting performance of the flash memory. Thus it can be necessary to write data to a flash memory using an algorithm capable of hiding the time required to erase data from the flash memory. A flash memory also can have limited erasure times, thus a block with excessively high erase count can become unusable since data can no longer be erased from such block. Thus it can be necessary to even the erase counts of the memory blocks.

Flash memory is accessed via a driver, which accepts reads and writes in units of sectors, corresponded to hard drive file system. If the driver writes data directly to the physical sector address, this could require an entire block to be erased during every write process, leading to slow access time and unevenly flash memory wear. Thus, repeated writes of a same data should be written to different physical locations of the flash memory. In other words, the address of a same data would be changed every time the data is rewritten. To present a consistent, e.g., unchanged, data address even though the data is written, logical addresses for the data are introduced, together with a mapping that translates the logical addresses to physical addresses. To the host system, the address of the data is the logical address, which is unchanged no matter how many times it is rewritten. The mapping can handle the address change, e.g., mapping the logical address of the data to different physical addresses in the flash memory every time the data is rewritten.

Thus an address mapping process and table, which translates logical addresses to physical addresses, is performed in the flash memory module upon writing data. A controller can be used to provide a logical address to an external host or processor, and also provide a physical address with respect to the solid state drive. The controller can manage the solid state drive using the physical addresses, and can convert the physical addresses into the logical addresses. A layer, e.g., an abstract concept of solid state drive partitions, in which logical addresses and physical addresses are converted from each other are typically referred to as a flash translation layer (FTL).

A solid state drive can be coupled to a host system, which interfaces with the solid state drive as though it were a hard disk drive. The solid state drive can contain a mapping table for mapping to addresses, e.g., converting between logical and physical addresses. The mapping table can be stored in the solid state drive on random access memory (RAM). The mapping table can be generated upon initialization, such as when it is connected to the host system. The mapping table can be lost when power is removed, such as when it is removed from the host system. Thus upon initialization, the solid state drive can be scanned to generate the mapping table. Some algorithms implement ways to preserve the mapping table to some extent across power lost in order to optimize the mapping table reconstruction process.

The FTL can use an address mapping table to perform a rapid address mapping operation, for example, RAM or static random access memory (SRAM). Using the address mapping function of the FTL, a host system can recognize the solid state drive as a hard drive, and can access the solid state drive in the same manner as the hard disk. The FTL can be included in the solid state drive and independent to the host system.

The address mapping methods can include a page-level address mapping method, a block-level address mapping method, and a hybrid address mapping method. In the page-level address mapping method, the unit of the mapping table is commonly page unit size, meaning a logical page of data is converted into a physical page. In the case of a block-level address mapping method, the unit of the mapping table is commonly block unit size, meaning a logical page of data is converted into a physical page.

Page-level address mapping can provide good performance due to address conversion with greater accuracy, but it can be expensive due to the large size requirement of the address mapping table. Block-level address mapping requires smaller size, but it can be expensive to manage because it must erase and update a whole data block even when a single page in the block is changed.

In the case of a hybrid mapping method, the mapping table can be either page unit or block unit size, such as using a page-level address mapping method over a log block and a block-level address mapping method over a data block.

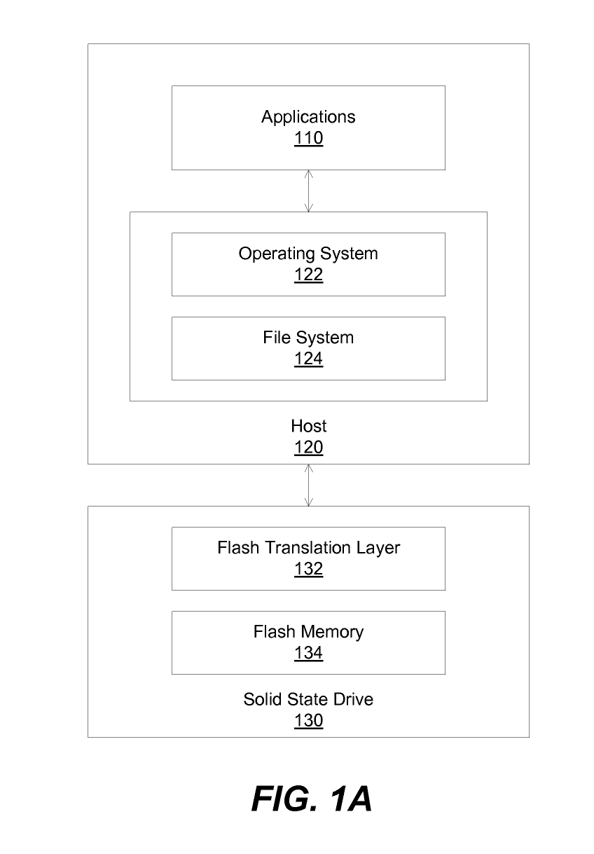

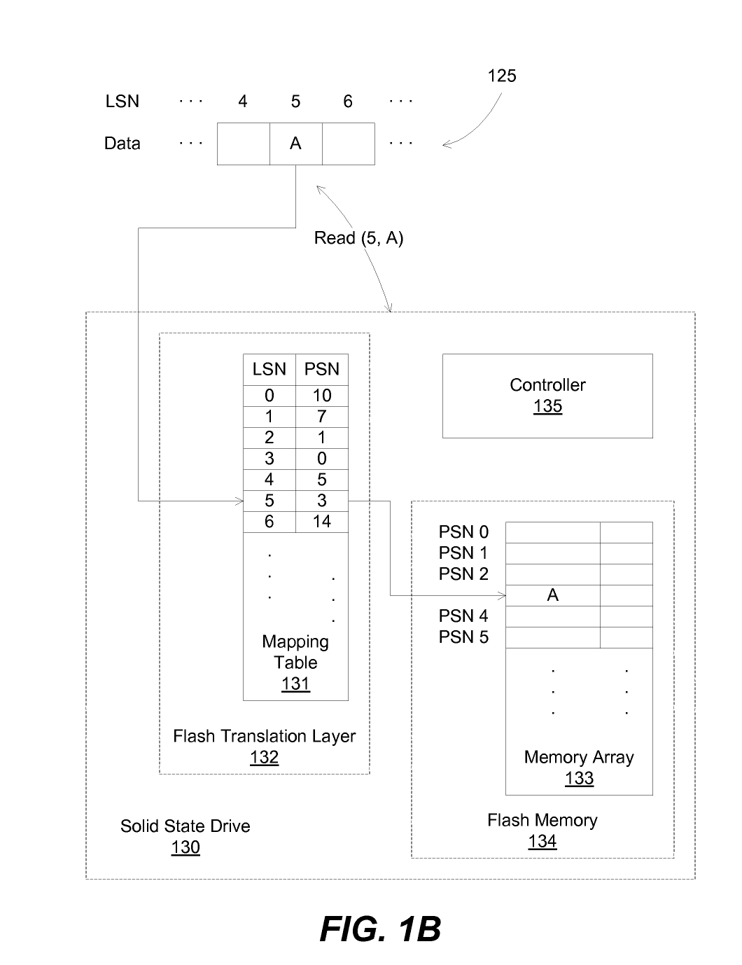

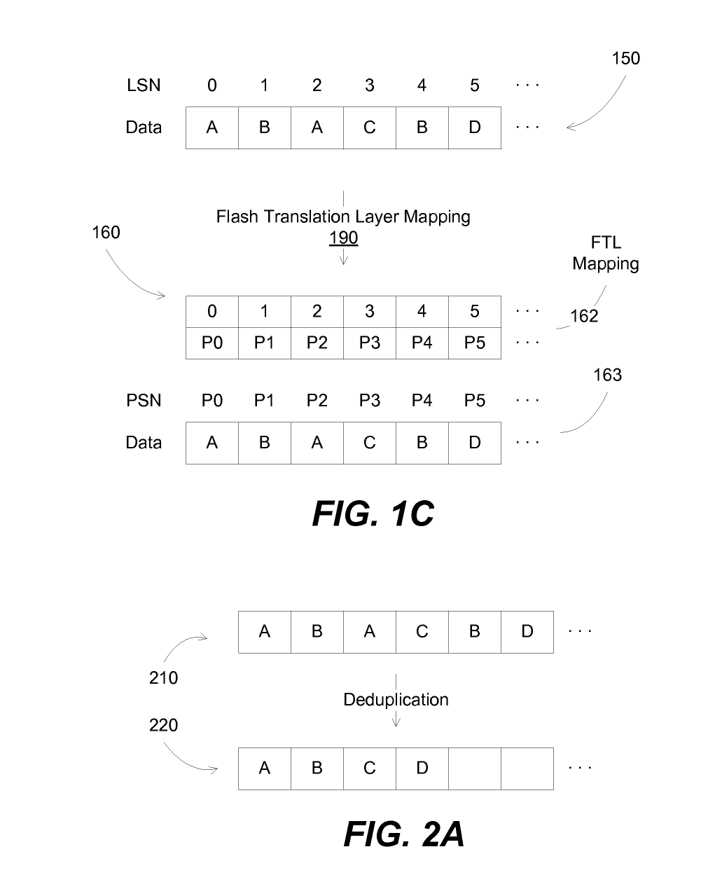

FIGS. 1A-1C illustrate a solid state drive and its operation according some embodiments. In FIG. 1A, a solid state drive 130 is coupled to a host system 120, such as a computer or a data processing system. The solid state drive 130 can include a flash memory 134. The flash memory 134 can include a set of flash memory packages, with each memory package having one or more dies. Each die can have multiple planes, which have many blocks, with each block having multiple pages.

The flash memory 134 can be connected to a controller for managing the memory. For example, the controller can include a host interface logic for communicating with the host 120, logic, memory buffer, and flash demux/mux to access the flash memory 134, optional memory such as RAM (read-write memory) for potential application software, and a flash translation layer 132.

The controller can utilize firmware, e.g., application software for the solid state drive 130, for many functions instead of hardware, for example, to reduce the cost of the solid state drives. For example, the firmware can include a flash translation layer mapping, which can map the physical addresses of the memory 134 to logical addresses that the host 120 requires. The flash translation layer mapping, e.g., a software loaded to the flash translation layer 132, can hide the characteristics of the flash memory 134, and can present the flash memory 134 under a file system 124 to the host 120, such as file systems utilized by hard drives.

The host 120 can include an operating system 122, such as Windows operating system or MAC operating system. The operating system 122 can be configured to recognize various file systems 124, such as FAT, NTFS, file systems used by Linux, or file systems used by MAC OS. The flash translation layer mapping, resided in the flash translation layer 132, can translate the characteristics of the file system 124 to the characteristics of the flash memory 134, allowing the host system 120, e.g., the applications 110 run by the host 120, to access the solid state drives without any knowledge of the internal structures and behaviors of the solid state drives. Thus despite the complexity and differences of the solid state drives, through the flash translation layer, the host system can view the solid state drive as a hard drive, with the characteristics indicated by the file system 124.

FIG. 1B shows an example of a read operation from the solid state drive 130. As mentioned above, the solid state drive 130 can include flash memory 134, which has a memory array 133, which are organized in blocks and pages, for example. The flash memory 134 can be identified by their physical addresses, such as physical sector number (PSN). The example shows an operation using sector identification, e.g., each logical address can correspond to a logical sector number (LSN), such as the sectors in a hard drive file system. Data in each sector can be stored in the flash memory at corresponding physical sector address number (PSN). Other methods of writing can be used, such as block identification, with each LSN and PSN representing a block of data, or hybrid identification using a combination of sectors and blocks.

The solid state drive 130 can include a flash translation layer 132, which has a logical-to-physical address mapping table 131. The logical-to-physical address mapping table 131 maps the logical address LSN to the physical address PSN. A firmware, e.g., a software program, can be loaded to the flash translation layer 132, for example, to perform the mapping, and/or to maintain the mapping table. A controller 135 can be included to perform other functions of the solid state drive 130.

During a read operation, a host system can issue a command 125, such as read (5, _), to read the data at logical address 5. From the host standpoint, the logical addresses can be those of any available file systems that the operating system supports, such as FAT or NTFS file system under Windows operating system. The command can be received by the solid state drive 130, which can translate the logical address LSN 5 to the physical address 3, for example, through the flash translation layer 132 or through the logical-to-physical address mapping table 131. The controller 135 then can issue a read command to retrieve the data, e.g., data A, at the flash memory having physical address PSN 3. The read command returns the data A, e.g., in the form of read (5, A).

FIG. 1C shows a schematic data reading by the host system from the solid state drive through a mapping from logical addresses LSN to physical addresses PSN by the flash translation layer mapping. The data 150 can exist in the host system in the form of logical addresses, for example, as corresponded sectors in a hard drive file system. The flash translation layer mapping 190 can store the data 150 in the solid state drive as a composite data 160, which includes flash translation layer mapping 162 and flash memory 163. The flash translation layer mapping 162 is configured to translate the logical addresses LSN recognized by the host system, e.g., LSN 0 , 1, . . . , to the physical addresses PSN recognized by the solid state drive, e.g., PSN P0, P1, . . . . The flash memory 163 contains the data, pointed by the physical addresses PSN.

The above description is overly simplified in order to illustrate the function of the flash translation layer or the logical-to-physical address mapping table. In practice, the flash memory at physical address might need to be erased by erasing a whole block containing the physical sector. Garbage data collection and wear leveling mechanisms also need to be implemented.

For example, a complete sequence of an out-of-place write can include choosing a free flash memory page, then writing the new data to it, followed by invalidating the previous version of the page involved, and then updating the logical-to-physical address map to reflect the address change. Thus the controller of the solid state drive can maintain a data structure for the pool of free flash memory blocks in which data can be written. The data pages of the free flash memory blocks can be allocated to the write requests can be dictated by a data placement function responsible for wear leveling, for example. The out-of-place write operation thus requires a garbage collection routine to reclaim invalid pages dispersed in flash memory blocks, copying valid pages out of the memory block, then erasing the block and adding the erased block to the pool of free blocks.

As a specific example, if a write command is executed instead of a read command (as shown in FIG. 1B), then the process can involve additional steps, depending whether or not the memory location has been erased, or whether the memory location contains valid data. Flash memory cannot be overwritten, e.g., if the memory contains valid data, then the memory needs to be erased before a new data can be written to that memory. In practice, if the memory contains valid data, a new memory is allocated for writing, and the flash translation table is updated to reflect the new mapping to the new memory. The old memory is marked so that it can be erased at a later time.

For example, if LSN 5 is currently mapped to PSN 3, that means, PSN 3 contains the valid data for LSN 5, so a read command will simply go read from physical location corresponding to PSN 3. However, if a write command comes in to LSN 5, now the firmware must allocates a new PSN, due to the constraint of “cannot overwrite the same physical region without erasing” of flash memory. Thus a new PSN, such as PSN 100, is allocated. The data A will then be written to the corresponding physical location of PSN 100. The mapping table will be updated such that LSN 5 will now maps to PSN 100 instead of PSN 3.

In some embodiments, the present invention discloses flash translation layers having deduplication mechanism. Deduplication is generally used to remove or compact redundant data stored on a storage device. Deduplication mechanism generally includes identifying identical data portions and store only a single copy.

The data portions can be subjected to a hash function to generate an output hash value. The hash values are compared to identify matched data portions. The hash functions can take any number of forms, including checksums, check digits, cryptographic functions, and parity values. A complex hash functions can include a Sha 256 hash of the input data, as well as one or more selected bit values of the Sha 256 hash value.

The hash values can be compared, for example, by a comparison module, to determine whether a match is detected. Multiple levels of hash values can be used in which simple hash functions can provide quick mismatch to avoid more complex hash function calculations and comparisons. To improve accuracy, strong hash function should be used.

Data deduplication reduces storage requirements of a system by removing redundant data, while preserving the appearance and the presentation of the original data.

For example, two or more identical copies of the same document may appear in storage in a computer and may be identified by unrelated names. Normally, storage is required for each document. Through data deduplication, the redundant data in storage is identified and removed, freeing storage space for other data. Where multiple copies of the same data are stored, the reduction of used storage may become significant. Portions of documents or files that are identical to portions of other documents or files may also be deduplicated, resulting in additional storage reduction.

To implement data deduplication, in one example, data blocks are hashed, resulting in hash values that are smaller than the original blocks of data and that uniquely represent the respective data blocks. A 20 byte SHA-1 hash or MD5 hash may be used, for example. Blocks with the same hash value are identified and only one copy of that data block is stored. Pointers to all the locations of the blocks with the same data are stored in a table, in association with the hash value of the blocks.

A remote deduplication appliance may be provided to perform deduplication of other machines, such as client machines, storing data to be deduplicated. The deduplication appliance may provide a standard network file interface, such as Network File System (“NSF”) or Common Internet File System (“CIFS”), to the other machines. Data input to the appliance by the machines is analyzed for data block redundancy. Storage space on or associated with the deduplication appliance is then allocated by the deduplication appliance to only the unique data blocks that are not already stored on or by the appliance. Redundant data blocks (those having a hash value, for example, that are the same as a data block that is already stored) are discarded. A pointer may be provided in a stub file to associate the stored data block with the location or locations of the discarded data block or blocks. No deduplication takes place until a client sends data to be deduplicated.

This process can be dynamic, where the process is conducted while the data is arriving at the deduplication appliance, or delayed, where the arriving data is temporarily stored and then analyzed by the deduplication appliance. In either case, the data set must be transmitted by the client machine storing the data to be deduplicated to the deduplication appliance before the redundancy can be removed. The deduplication process is transparent to the client machines that are putting the data into the storage system. The users of the client machines do not, therefore, require special or specific knowledge of the working of the deduplication appliance. The client machine may mount network shared storage (“network share”) of the deduplication appliance to transmit the data. Data is transmitted to the deduplication appliance via the NFS, CIFS, or other protocol providing the transport and interface.

When a user on a client machine accesses a document or other data from the client machine the data will be looked up in the deduplication appliance according to index information, and returned to the user transparently, via NSF or CIFS, or other network protocols. If a user decides to copy a document from a first location to a second location, for data management operations, for example, the entire data set must be retrieved from the deduplication appliance and sent back to the client machine. If the destination location happens to be the deduplicated appliance, the copy of the data in the second location will be deduplicated again, as new data to be backed up. This is cumbersome, and may require use of a lot of network bandwidth and CPU usage in the client and the deduplication appliance.

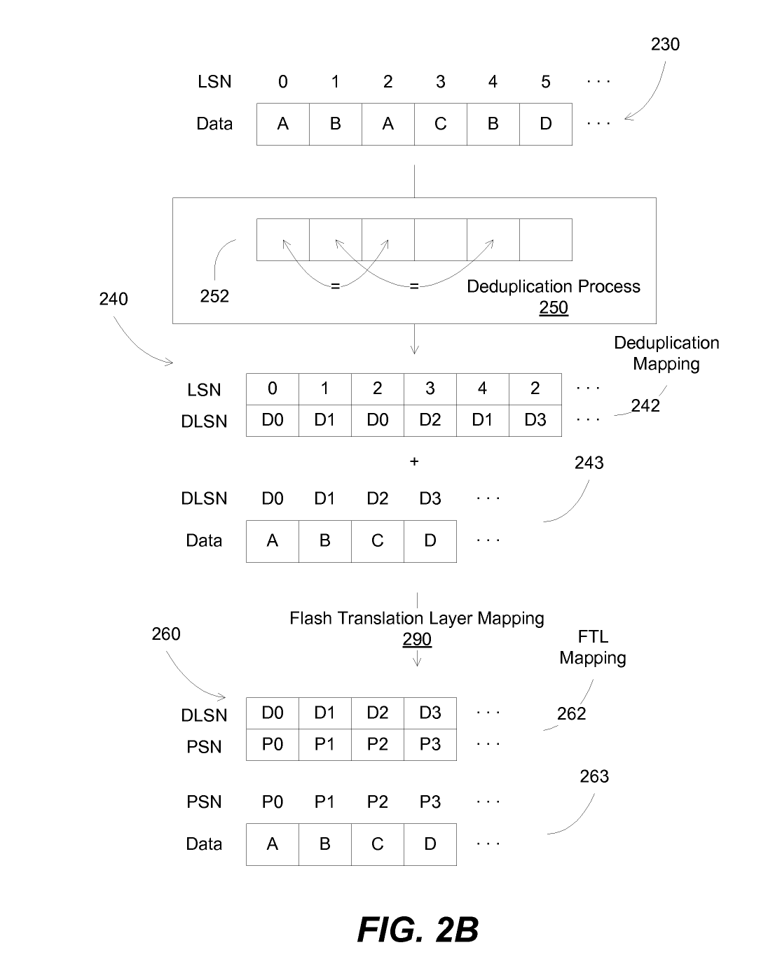

FIGS. 2A-2B illustrate schematics of a deduplication mechanism according to some embodiments. FIG. 2A shows a general concept of a deduplication mechanism. Data 210 can include duplicated blocks, such as block A and block B. After applying a deduplication process to the data 210, a deduplicated data 220 can be generated, in which only the data blocks that are not duplicated are stored, e.g., blocks A and B are stored only one copy each in the deduplicated data 220.

FIG. 2B shows a schematic of a deduplication mechanism. Data 230 can have duplicated blocks, such as block 0 (having LSN 0) and block 2 (having LSN 2) are duplicated with data A. A deduplication process 250 can be applied to the data 230, generating a mapping table 252 such as a hash table, which can identify the duplicated blocks. For example, data in each block are compared with data in other blocks, resulting in mapping table 252 showing that blocks 0 and 2 are duplicated and blocks 1 and 4 are duplicated. Alternatively, a hash function can be used to compare the data blocks, with faster process time but with less accuracy, e.g., there is a small probability that two different data blocks having a same hash function.

As a result of the deduplication process, a composite data structure 240 can be generated, which includes a deduplication mapping 242 and a deduplicated data storage 243. The deduplication mapping 242 maps the addresses LSN of the original data 230 to the addresses DLSN. The mapping can be multiple to one, e.g., two or more LSN addresses can be mapped to a same DLSN address, to accommodate the deduplication process. For example, LSN 0 and LSN 2 are mapped to DLSN D0, identifying that LSN 0 and LSN 2 contain a same data stored in DLSN D0. Similarly, LSN 1 and LSN 4 are mapped to DLSN D1, identifying that LSN 1 and LSN 4 contain a same data stored in DLSN D1. Deduplicated data storage 243 can contain deduplication data, e.g., data without any duplication. Thus only 4 data are stored in deduplicated data storage 243, with deduplicated addresses D0-D3, as compared to 6 data in the original data 230 with addresses LSN 0-LSN 5.

The deduplication mapping 242 can allow the retrieval of data from the deduplicated data storage 243, e.g., a reference to a LSN address can retrieve the correct data from the deduplicated data 243. For example, to get the data for LSN 2, the deduplication mapping 242 translates the LSN 2 to DLSN 0, which can be used to get the data A in the deduplicated data 243 at DLSN 0.

FIG. 2B also shows a scenario in which the deduplicated data can be stored in a solid state drive. A flash translation layer mapping 290 can map the deduplicated addresses DLSN to the physical address PSN of the solid state drive so that the deduplicated data can be stored at the physical address PSN. The translation layer mapping 290 can form composite data structure 260, which includes a FTL mapping 262 and a flash memory data storage 263. The flash translation layer mapping 262 is configured to translate the logical addresses DLSN, which is the deduplicated addresses converted from the LSN addresses recognized by the host system, to the physical addresses PSN recognized by the solid state drive, e.g., PSN P0, P1, . . . . The flash memory 263 contains the data, pointed by the physical addresses PSN.

In some embodiments, the present invention discloses an integrated mapping which combines the translation of logical to physical address of a solid state drive with the translation of duplicated data to deduplicated data of a deduplication mechanism. The integrated mapping can form solid state drives with deduplication features, for example, without additional hardware or software. The integrated mapping can include a synergy between the solid state drive, e.g., the firmware in the flash translation layer, and the deduplication mechanism to reduce the overhead of deduplication mechanism.

For example, generally a hash or mapping is required to implement the deduplication feature. If the deduplication mapping is performed outside of the storage device knowledge, this mapping must always reside in memory in order for the storage device to be functional. If the host system is to be shut down, this information must be stored to a storage device, either to the same device or to a different device. The deduplication process can end at this stage since it cannot operate on itself without making further changes.

In contrast, the integrated mapping can implement the mapping within the storage device itself, e.g., optimally combining the two mappings to form a synergetic deduplication mapping. The deduplication algorithms can be implemented in the host system or in the storage device. For example, a deduplication algorithm can be implemented in the application layer, which can freely communicate with the storage device and perform computationally expensive operations related the deduplication algorithm. Further, different deduplication algorithms could be implemented in the application layer, independent of the storage device firmware.

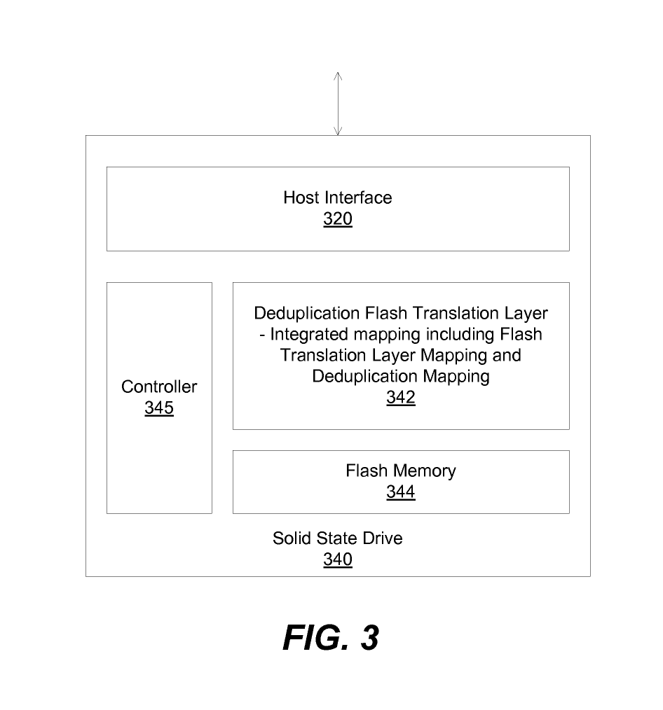

FIG. 3 illustrates a solid state drive having an integrated or synergetic deduplication mapping according to some embodiments. A solid state drive 340 can include a host interface 320 for communicating with a host system, such as a computer or a data processing system. The solid state drive 340 can include a flash memory 344 for storing the data, a controller 345 to manage the memory, and a deduplication flash translation layer 342.

The integrated deduplication flash translation layer 342 can include firmware, e.g., a software program for performing deduplication flash translation layer mapping, which integrates a mapping between the physical addresses of the memory to the logical addresses that the host requires, with a mapping generated by a deduplication mechanism.

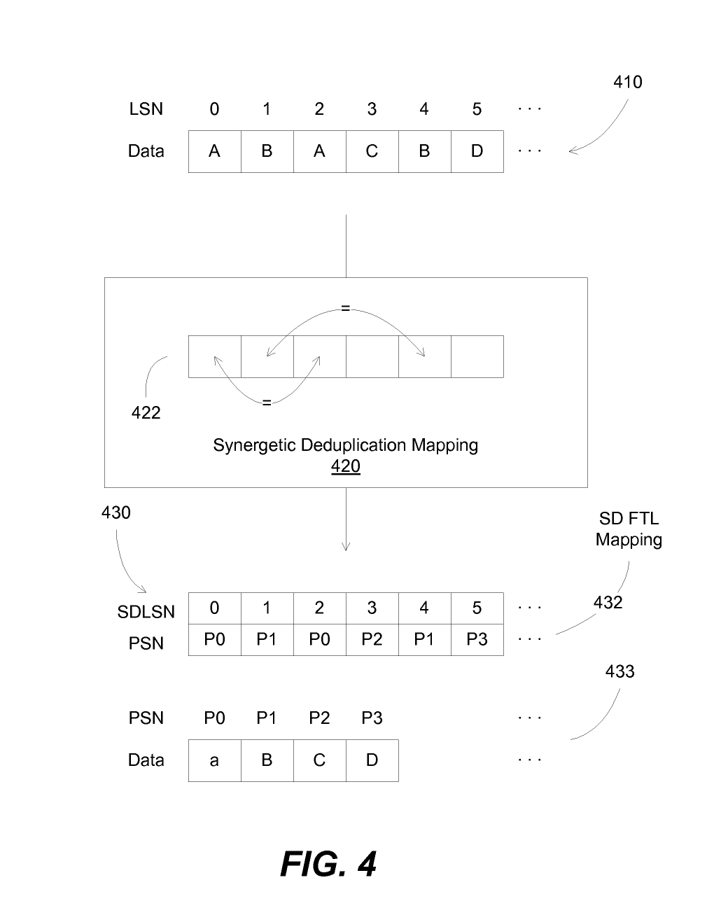

FIG. 4 illustrates a schematic of an integrated deduplication flash translation layer mapping according to some embodiments. In the present description, the term integrated deduplication flash translation layer mapping can be used interchangeably with the term synergetic deduplication mapping, to include a meaning of a single mapping that combines a logical-to-physical mapping typical of solid state drives with a deduplication mapping.

A synergetic deduplication mapping 420 can translate data/logical addresses 410 to deduplicated data/physical addresses 430. The mapping 420 can include a mapping from logical address LSN addressed by the host system to the physical address PSN addressed by the solid state drive. The mapping 420 can include a deduplication mapping that maps logical addresses LSN of identical data blocks to same physical addresses PSN, together with storing only one copy of duplicated data blocks. The synergetic deduplication mapping can also generate or receive a comparison of the data blocks, for example, to generate a hash table 422 that shows the blocks that are identical.

In some embodiments, the synergetic deduplication mapping can be operable to generate a composite data structure 430, which includes a synergetic deduplication mapping 432 and a data storage 433. The synergetic deduplication mapping 432 can function as a flash translation layer, e.g., mapping the logical addresses LSN of the data to the physical addresses PSN of the memories of the solid state drive. The synergetic deduplication mapping 432 can also function as a deduplication mapping, e.g., mapping two or more logical addresses that contain a same data to a same physical address PSN. Thus the synergetic deduplication mapping 432 can be called a synergetic deduplication FTL mapping (SD FTL mapping), which can perform a synergetic mapping between a FLT mapping and a deduplication mapping. To provide a distinction between a SD FTL mapping with a conventional FTL mapping, the logical addresses of the SD FTL mapping can be called SDLSN, as compared to logical addresses LSN of the conventional FTL mapping. The logical addresses SDLSN and LSN can be similar, e.g., denoting the logical addresses of the data, such as from a host point of view. The distinction between SDLSN and LSN can be considered as from the mapping, and not from the notation.

SD FTL mapping: SDLSN→PSN

FTL mapping: LSN→PSN

In some embodiments, the synergetic deduplication mapping can be a mapping from addresses to addresses, which can map logical addresses SDLSN in data structure 430, e.g., logical addresses LSN from the original data structure 410, to physical addresses PSN of the solid state drive. In addition, the mapping can be a multiple-to-one mapping, e.g., mapping multiple SDLSN to a same PSN. The multiple-to-one mapping is formed to handle deduplication, e.g., the SDLSN of multiple identical data blocks are mapped to a single PSN, so that only one copy of the multiple identical data blocks can be stored in the solid state device. For example, the logical addresses LSN 0 and 2 of the original data 410 (e.g., SDLSN 0 and 2 of synergetic deduplication data structure 430) can be mapped to a same physical address PSN P0, so that both data blocks pointed to by LSN 0 and 2 can be stored and retrieved from PSN P0. Similarly, logical addresses LSN 1 and 4 can be mapped to PSN P1, which stored data B. Logical addresses that pointed to unduplicated data blocks, such as LSN 3 and 5 can be mapped to single individual PSN P2 and P3. Using the synergetic deduplication mapping 420, deduplication can be performed on the data blocks 410 together with the mapping from logical to physical address used in solid state drive. For example, with 6 data blocks being used in the data 410, only 4 data blocks are used in the solid state drive, with the 2 duplicated data blocks excluded from being copying to the storage.

In some embodiments, the synergetic deduplication mapping can be include a deduplication mapping and a logical-to-physical address mapping (in either order), together with a consolidation of the two mappings to form an integrated mapping. Individual elements can be performed in sequence or in parallel, e.g., deduplication element, logical-to-physical mapping element, and integration element can be individually completed. For example, the data can undergo deduplication mapping, followed by logical-to-physical address mapping, and then the two mappings are integrated to form a single synergetic deduplication mapping. Other methods can also be used, such as the data can undergo logical-to-physical address mapping, followed by deduplication mapping, and then the two mappings are integrated to form a single synergetic deduplication mapping.

Alternatively, integrated algorithms can be used, such as evaluating the incoming data and the possible memory locations in the solid state drive, and producing a synergetic deduplication mapping. The integrated algorithms can blur the distinction between the separate elements, for example, to optimize the process.

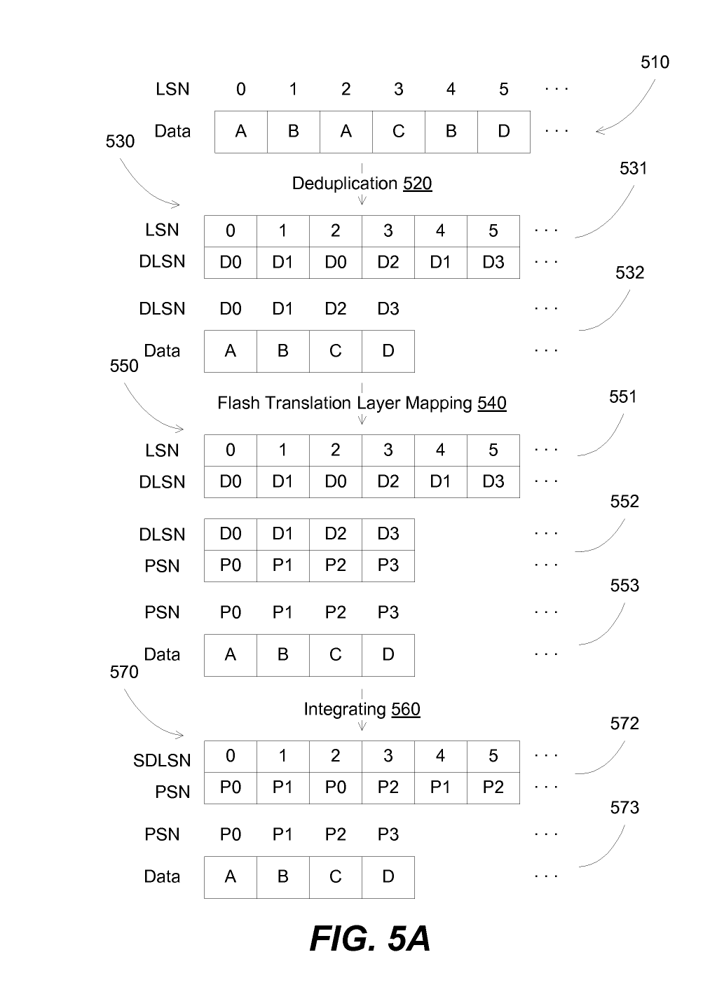

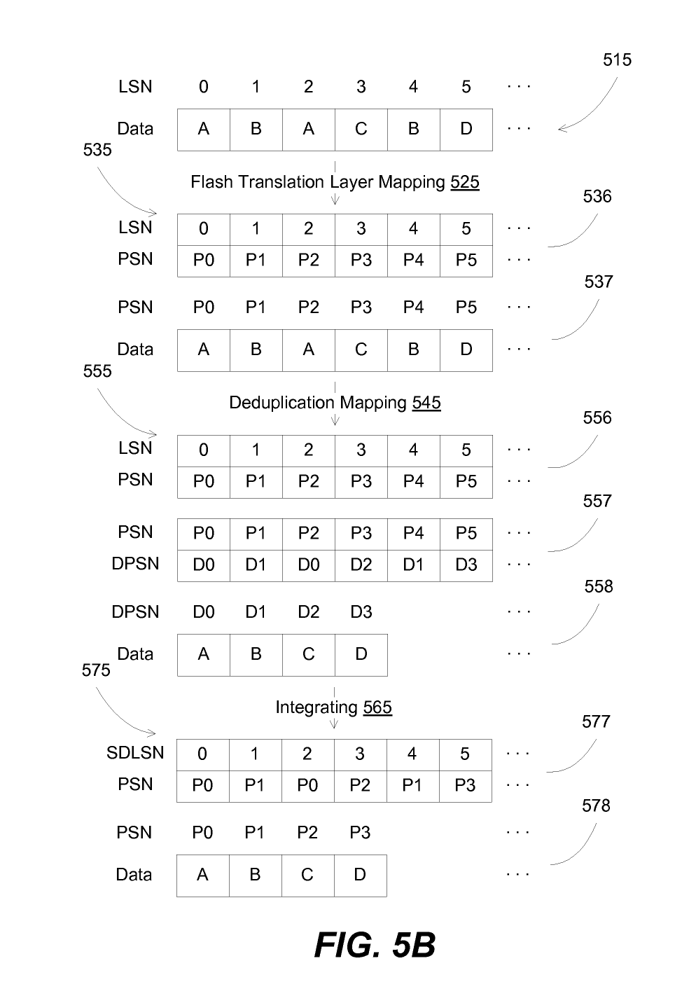

FIGS. 5A-5B illustrate concepts of synergetic deduplication mapping according to some embodiments. In FIG. 5A, a deduplication mapping 520 is performed before a logical-to-physical address mapping (sometimes called flash translation layer mapping) 540, and then the two mappings are integrated to form a synergetic deduplication mapping 560.

Data 510 can include data blocks pointed to by logical addresses LSN. A deduplication mapping algorithm can be performed on the data 510, generating deduplicated data blocks 530, which include deduplication mapping 531 and deduplicated data blocks 532. As shown, data in the deduplicated data blocks 532 has been deduplicated, e.g., multiple identical data blocks are reduced to single storage instances. For example, duplicated data blocks A and B in original data 510 are removed in deduplicated data blocks 530. The deduplication mapping links the duplicated logical addresses LSN 0/2 and 1/4 to same deduplication addresses 0 and 1.

Data 530 can undergo logical-to-physical address mapping 540 to generate physical data blocks 550, which include FTL logical-to-physical address mapping 552 and data blocks 553 to be stored in the solid state drive. Since the physical data blocks 550 is also a result of a deduplication mapping 520, deduplication mapping 551 is also included in the physical data blocks 550. In the mapping 540, physical addresses can be generated, for example, based on wear leveling and other considerations, such as block erase algorithms. The mapping 540 can consider only the deduplicated data blocks, thus only deduplication blocks D0-D3 have corresponding physical addresses PO-P3, and only the deduplicated data blocks A, B, C, and D are stored in the solid state drive under these physical addresses.

An integration processes 560 can be performed to combine these two mappings, to generate synergetic data blocks 570, which include synergetic deduplication mapping 572 and synergetic deduplication data blocks 573. The synergetic deduplication mapping 572 can be a composite mapping of the deduplication mapping 551 and the logical-to-physical mapping 552. The synergetic deduplication data blocks 573 can be similar to the data blocks 553, which include deduplicated data blocks, addressed by physical addresses PSN P0-P3.

In FIG. 5B, a deduplication mapping 525 is performed after a logical-to-physical address mapping 545, and then the two mappings are integrated to form a synergetic deduplication mapping 565.

Data 515 can include data blocks pointed to by logical addresses LSN. Data 515 can undergo logical-to-physical address mapping 525 to generate physical data blocks 535, which include FTL logical-to-physical address mapping 536 and data blocks 537 to be stored in the solid state drive. In the mapping 525, physical addresses can be generated, for example, based on wear leveling and other considerations.

A deduplication mapping algorithm 545 can be performed on the data 535, generating deduplicated data blocks 555, which include deduplication mapping 557 and deduplicated data blocks 558, together with the logical-to-physical mapping 556. As shown, data in the deduplicated data blocks 532 has been deduplicated, e.g., multiple identical data blocks are reduced to single storage instances. For example, duplicated data blocks A and B in data blocks 535 are removed in deduplicated data blocks 555. As shown, the deduplication mapping is based on physical addresses, e.g., translating from physical address PSN generated by the logical-to-physical address mapping 525 to deduplication physical address DPSN. Since the physical data blocks 558 is also a result of a logical-to-physical address mapping 525, logical-to-physical address mapping 556 is also included in the physical data blocks 555.

An integration processes 565 can be performed to combine these two mappings, to generate synergetic data blocks 575, which include synergetic deduplication mapping 577 and synergetic deduplication data blocks 578. The synergetic deduplication mapping 577 can be a composite mapping of the deduplication mapping 556 and the logical-to-physical mapping 557. The synergetic deduplication data blocks 578 can be similar to the data blocks 558, which include deduplicated data blocks, addressed by physical addresses PSN P0-P3.

The above description serves to illustrate possible implementations of synergetic deduplication mapping, and does not limit the scope of the present invention. Other implementations can be used, which can provide a synergetic deduplication that includes a single mapping with the functionalities of deduplication and logical-to-physical address translation.

In some embodiments, the present invention discloses solid state drives, controllers in the solid state drives, and host system utilizing the solid state drives, that can perform synergetic deduplication, e.g., storing data having logical addresses to the solid state drives using physical addresses of the solid state drive, together with deduplicating the data in the memory of the solid state drive. The solid state drives can also allow the retrieval of the data while automatically reversing the deduplication process, by looking at the address mapping to obtain the data.

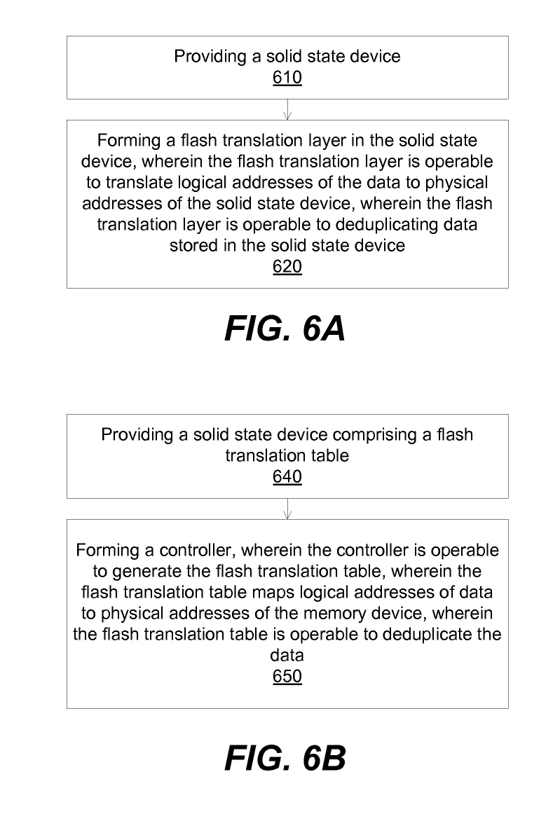

FIGS. 6A-6B illustrate flowcharts for forming solid state drives having synergetic deduplication mapping according to some embodiments. In some embodiments, a flash translation layer can be formed in the solid state drive that can perform a synergetic deduplication mapping, e.g., after receiving a data set with logical addresses, and optional information related to duplicated data blocks from the data set, the flash translation layer can be operable to produce a synergetic deduplication mapping that integrates logical-to-physical address translation and deduplication mapping.

In some embodiments, a controller can be formed in the solid state drive that can perform a synergetic deduplication mapping. In some embodiments, a firmware can be loaded, e.g., installed, in the solid state drive, such as in the flash translation layer of the solid state drive to translate the incoming data having logical addresses to deduplicated data having physical addresses to be stored in the solid state drive.

In FIG. 6A, operation 610 provides a solid state device. The solid state drive can have flash memory arrays, which need to have a translation mapping to access the memory, e.g., through a mapping of logical addresses to physical addresses of the memory.

Operation 620 forms a flash translation layer in the solid state device. The flash translation layer can be operable to translate logical addresses of the data to physical addresses of the solid state device. The flash translation layer can also be operable to deduplicating data stored in the solid state device. The address translation and the deduplication mapping can be integrated to a single mapping in the flash translation layer, offering synergy between the data storage mechanism with the deduplication mechanism.

In some embodiments, forming the flash translation layer includes forming a flash translation table, which is operable to map one or more logical addresses to one physical address, e.g., the mapping is multiple to one. The multiple-to-one mapping characteristic can allow the flash translation table to handle deduplication, since multiple logical addresses of identical data blocks can be mapped to one physical address, allowing the storage drive to store only one copy of the multiple identical data blocks. In some embodiments, forming the flash translation layer includes forming an integrated mapping table having flash translation layer mapping and deduplication mapping.

The deduplication algorithm can be performed outside the solid state drive, such as at the host system, for example, to take advantages of the computational power of the host system. Alternatively, the deduplication algorithm can be performed by the solid state drive, e.g., through a software or firmware installed in a layer of the solid state drive, such as in the flash translation layer or in the application layer.

In FIG. 6B, operation 640 provides a solid state device having a flash translation table. The flash translation table can be located in a flash translation layer of the solid state drive. The flash translation table can be formed by a firmware of software, for example, installed in the flash translation layer or in a controller of the solid state drive.

Operation 650 forms a controller in the solid state drive. The controller can be operable to generate the flash translation table, which can maps logical addresses of data to physical addresses of the memory device, together with the ability to deduplicate the data. For example, the flash translation table can be operable to map logical addresses to physical addresses, e.g., receiving data having logical addresses from a host system, and translating the logical addresses to physical addresses of the solid state drive, taken into account the different characteristics of the solid state drive, such as block erase, garbage collection, and wear leveling.

In some embodiments, the controller can be operable to form the flash translation table or mapping. The mapping can be operable to translate logical addresses to physical addresses and the mapping can be multiple to one.

In some embodiments, the controller can be loaded, e.g., installed, with a firmware, e.g., a software for operating the solid state drive. The firmware can be operable to form the flash translation table or mapping.

In some embodiments, the present invention discloses mapping tables, controllers utilizing the mapping tables in solid state drives, methods to form mapping tables, and software or firmware that can access or generate mapping tables, that can allow synergetic deduplication in solid state drives. The mapping tables can also allow the retrieval of the data from the solid state drives while automatically reversing the deduplication process.

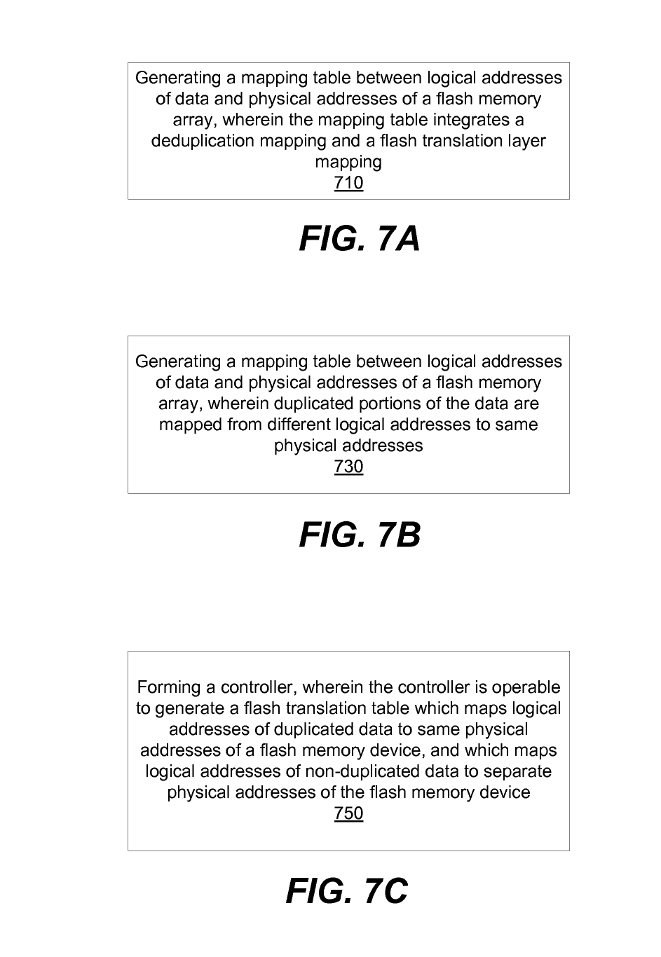

FIGS. 7A-7C illustrate flow charts for forming mapping table in a solid state drive according to some embodiments. In FIG. 7A, operation 710 generates a mapping table between logical addresses of data and physical addresses of a flash memory array. The mapping table also integrates a deduplication mapping and a flash translation layer mapping. In some embodiments, data can be stored in the solid state drive. Storing data can include generating a mapping table which integrates a deduplication mapping and a flash translation layer mapping

In FIG. 7B, operation 730 generates a mapping table between logical addresses of data and physical addresses of a flash memory array. The mapping table is configured so that duplicated portions of the data are mapped from different logical addresses to same physical addresses.

In some embodiments, the mapping table can be a mapping between logical addresses and physical addresses, wherein two logical addresses are mapped to a same physical address if the data corresponded to the two logical addresses are the same, wherein two logical addresses are mapped to two different physical addresses if the data corresponded to the two logical addresses are different.

In FIG. 7C, operation 750 forms a controller in a solid state drive. The controller can be operable to generate a flash translation table which maps logical addresses of duplicated data to same physical addresses of a flash memory device, and which maps logical addresses of non-duplicated data to separate physical addresses of the flash memory device. In some embodiments, a firmware can be installed in a solid state drive to generate or operate the flash translation table. For example, the firmware can generate the table, which contains mapping between logical addresses and physical addresses, together with a multiple-to-one characteristic to allow deduplication mapping. Alternatively, the firmware can have an algorithm to generate physical addresses, together with algorithm to map logical addresses to physical addresses, with or without maintaining a table.

In some embodiments, the present invention discloses methods to store data in solid state drives with deduplication feature. By using a synergetic deduplication mapping in the solid state drives, e.g., an integrated mapping that combines address translation and deduplication mapping, data in a host system can be deduplicately stored in the solid state drives, despite the difference in file formats since the synergetic deduplication mapping can provide a translation between logical addresses and physical addresses.

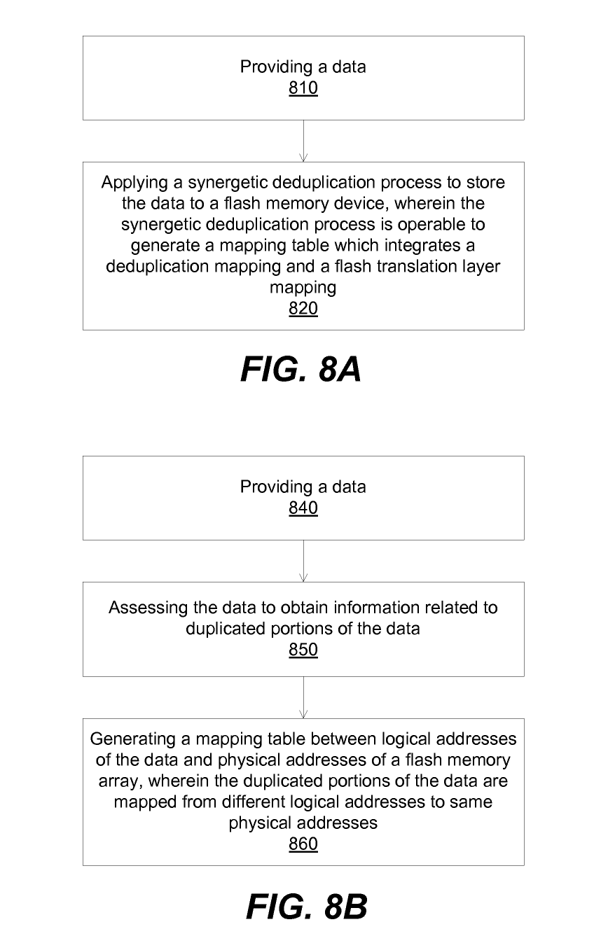

FIGS. 8A-8B illustrate flow charts for methods to store data in a solid state drive with deduplication feature according to some embodiments. The methods can include applying a synergetic deduplication process while storing the data. The methods can include using an integrated mapping that is a combination of logical-to-physical address translation and deduplication mapping.

In FIG. 8A, operation 810 provides a data. The data can be originated from a host system, using logical addresses according to a supported file system. Operation 820 applies a synergetic deduplication process to store the data to a solid state drive, such as a flash memory device. The synergetic deduplication process can be operable to generate a mapping table which integrates a deduplication mapping and a flash translation layer mapping, e.g., a logical-to-physical address mapping or translation.

In FIG. 8B, operation 840 provides a data, for example, to be stored in a solid state drive. The data can be originated from a host system, using logical addresses according to a supported file system. Operation 850 assesses the data to obtain information related to duplicated portions of the data. The assessment can be performed by comparing blocks of the data to obtain information about identical blocks. The comparison can be done by using a hash table, trading accuracy for speed. The assessment can be performed by the host system, utilizing the high computational power of the host system, e.g., through the host central processor. The assessment can be performed by the solid state drive, using a deduplication algorithm stored in the solid state drive, such as in an application layer of the solid state drive.

Operation 860 generates a mapping table between logical addresses of the data and physical addresses of a flash memory array, with the duplicated portions of the data mapped from different logical addresses to same physical addresses. The mapping can be an integration of a deduplication mapping and a logical-to-physical address mapping. The mapping can be a synergetic deduplication mapping, in which the deduplication mapping can be performed in the solid state drive during the translation from logical addresses to physical addresses.

In some embodiments, the present invention discloses methods to store data to a solid state drive according to some embodiments. The solid state drive can have address mapping or translation to allow a host system using various file systems, which can be different from the data storage methodology in the solid state drive. The solid state drive can have deduplication mechanism, allowing multiple duplicated data blocks to have one stored copy. The solid state drive can coordinate the address mapping and the deduplication mapping, providing an integrated mapping having synergy between the two mappings.

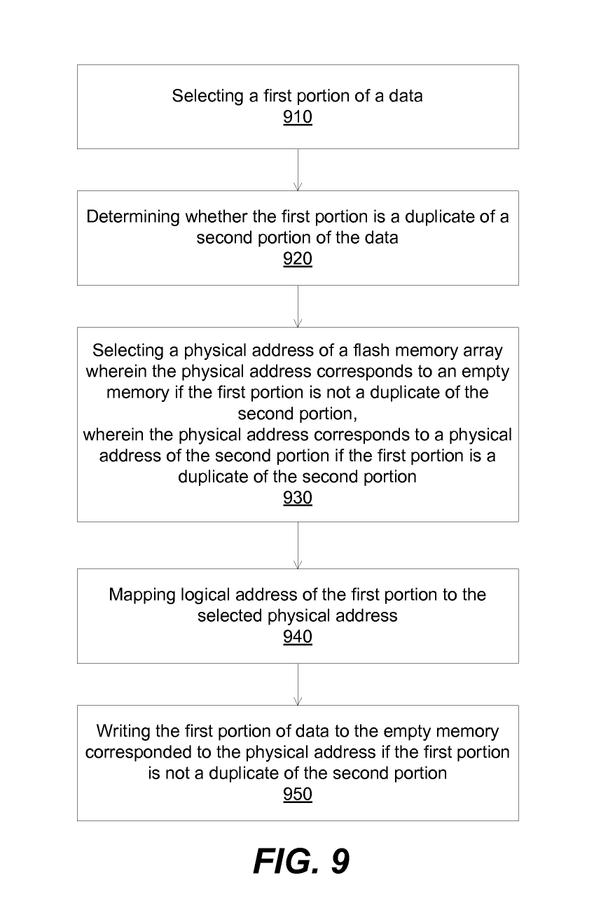

FIG. 9 illustrates a flow chart for methods to store data in a solid state drive with deduplication feature according to some embodiments. The methods can use a synergetic deduplication process to allow the solid state drive to coordinate an address mapping with a deduplication mapping.

Operation 910 selects a first portion of a data to be stored in a solid state drive. Operation 920 determines whether the first portion is a duplicate of a second portion of the data. The second data portion can be a data portion that has been evaluated. This process can be performed in the solid state drive, or by a host system that accesses the solid state drive. Operation 930 selects a physical address of a flash memory array. The physical address can be selected based on a deduplication requirement. The physical address can be selected based on characteristics of the solid state drive, such as wear leveling, block erase algorithm, or garbage collection algorithm. For example, the selected physical address can correspond to an empty memory, e.g., a free memory, if the first portion is not a duplicate of the second portion. This can allow new data to be written to the memory. The selected physical address can correspond to a physical address of the second portion if the first portion is a duplicate of the second portion. This can allow duplicated data not to be written to the memory, but only to a physical address that contains the duplicated data.

Operation 940 maps the logical address of the first portion to the selected physical address. If the data is not a duplicated data, the logical address of the data is mapped to a new physical address, e.g., a physical address of a free memory in the solid state drive. If the data is a duplicated data, the logical address of the data is mapped to the existed physical address of the duplicated data that has been written before.

Operation 950 writes the first portion of data to the empty memory corresponded to the physical address if the first portion is not a duplicate of the second portion. The operation is skipped if the first data portion is a duplicated of the second data portion, thus allowing the data to be stored with duplication.

In some embodiments, the present invention discloses methods to store data to a solid state drive according to some embodiments. A duplication algorithm can be performed on the data to obtain information related to data blocks that are duplicated of each other, allowing the data can be stored without being duplicated.

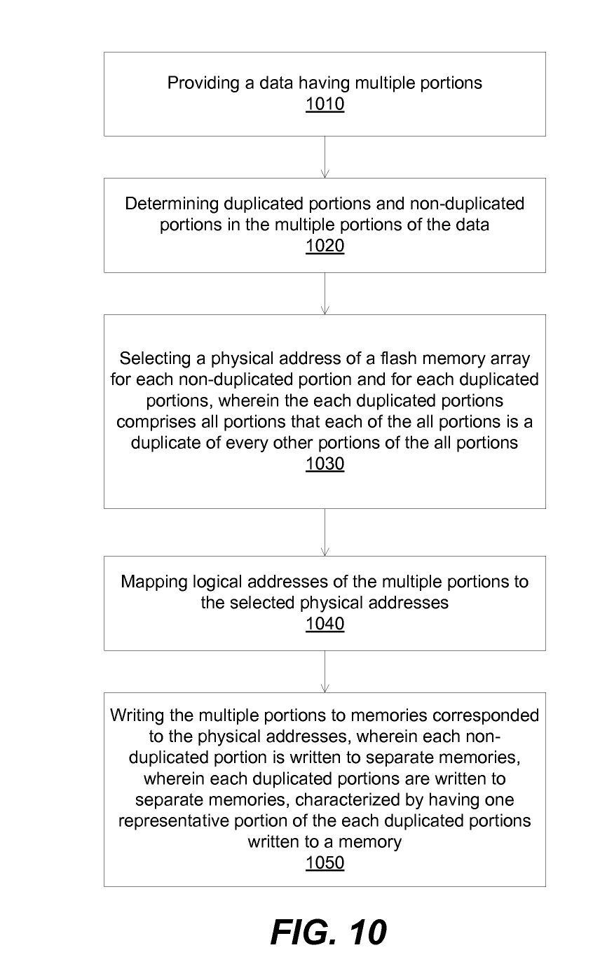

FIG. 10 illustrates a flow chart for methods to store data in a solid state drive with deduplication feature according to some embodiments. The methods can use a synergetic deduplication process to allow the solid state drive to coordinate an address mapping with a deduplication mapping.

Operation 1010 provides a data having multiple portions. The data can be designed to be stored in a solid state drive. Operation 1020 determines duplicated portions and non-duplicated portions in the multiple portions of the data. This process can be performed in the solid state drive, or by a host system that accesses the solid state drive. This process can be performed using a hash algorithm.

Operation 1030 selects a physical address of the solid state memory array for each non-duplicated portion and for each group of duplicated portions. For example, a non-duplicated portion can be a portion that is different from all other portions. Each group of duplicated portions can include multiple portions that are duplicated of each other, e.g., all portions in the group of duplicated portions can be identical to each other.

Operation 1040 maps logical addresses of the multiple portions to the selected physical addresses. The logical addresses of each portion can be mapped to corresponded selected physical addresses. For example, a non-duplicated portion can be mapped to a separate physical address. Each portion of a group of duplicated portions can be mapped to a same physical address. Different groups of duplicated portions can be mapped to different physical addresses.

Operation 1050 writes the multiple portions to memories corresponded to the physical addresses. For example, a non-duplicated portion can be written to a memory pointed to by the corresponded physical address. One portion of each group of duplicated portions can be written to a memory pointed to by the corresponded physical address. Thus the writing process can eliminate duplicated writing, e.g., only one portion is written for a group of duplicated portions.

In some embodiments, the present invention discloses methods to read data from a solid state drive according to some embodiments. The data can be stored in the solid state drive with deduplication feature.

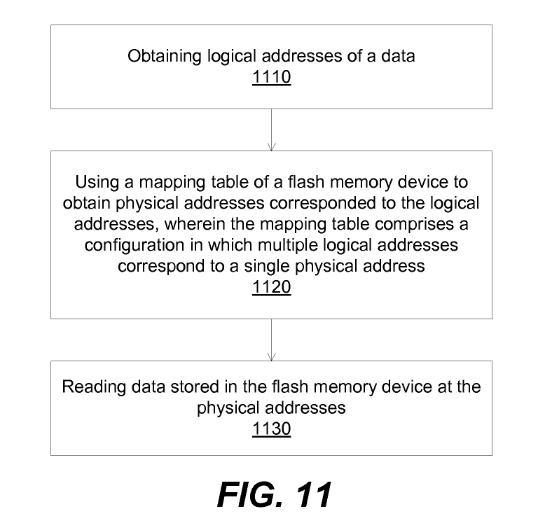

FIG. 11 illustrates a flow chart for methods to read data in a solid state drive with deduplication feature according to some embodiments. The data can be stored using a synergetic deduplication process.

Operation 1110 obtains logical addresses of a data, for example, by a host system with the logical addresses corresponded to a supported file system of the host system. Operation 1120 uses a mapping table of a solid state drive to obtain physical addresses corresponded to the logical addresses. The mapping table can include a configuration in which multiple logical addresses correspond to a single physical address, which can allow the data to be stored without being duplicated. Operation 1130 reads the data stored in the solid state drive at the physical addresses.

In some embodiments, the present invention discloses a synergetic deduplication for solid state drive. In the synergetic deduplication, the deduplication mechanism or algorithm can be performed in the host system or by the solid state drive. The host system can have high computational power with large memory, together with the flexibility of using different deduplication algorithms, while the solid state drive can provide an integrated solution.

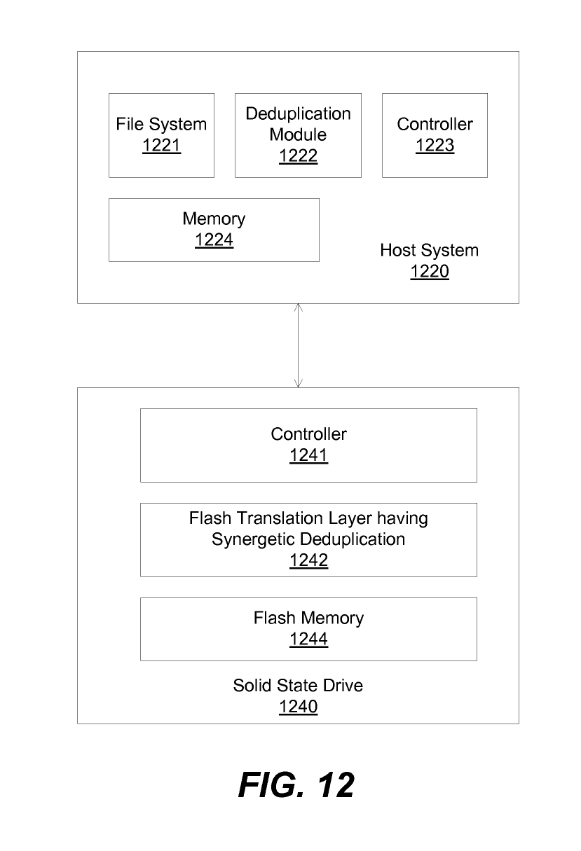

FIG. 12 illustrates a system for synergetic deduplication according to some embodiments. A solid state drive 1240 can have a memory component, such as flash memory 1244, a flash translation layer 1242 having synergetic deduplication, and a controller 1241. The flash translation layer 1242 can include software or firmware to generate or manage a synergetic deduplication mapping, which integrates logical-to-physical address mapping and deduplication mapping. The controller 1241 can be configured to perform other functions of the solid state drive, such as communication with a host system 1220, and other functions related to the flash memory management such as memory selection, wear leveling, garbage collection, etc.

The host system 1220 can include memory 1224, file system configuration 1221, deduplication module 1222, and controller 1223. The file system configuration 1221 can include features of accessible files, such as arrangements of memory. The controller 1223 can be used to run programs, which can uses memory 1224. Deduplication module 1222 can include deduplication algorithm for evaluating deduplicated portions of a data.

For example, the host system can have a data arranged according to the file system. The host system can store the data to the solid state drive. The deduplication module can access the data to determine duplicated portions, and the data and the deduplication information are sent to the solid state drive. The access and writing can be performed inline, e.g., each portion of the data is read, evaluated for duplication, and then written to the solid state drive sequentially. The access and writing can be performed in batch, e.g., all data is read and evaluated for duplication, before the data is written to the solid state drive sequentially.

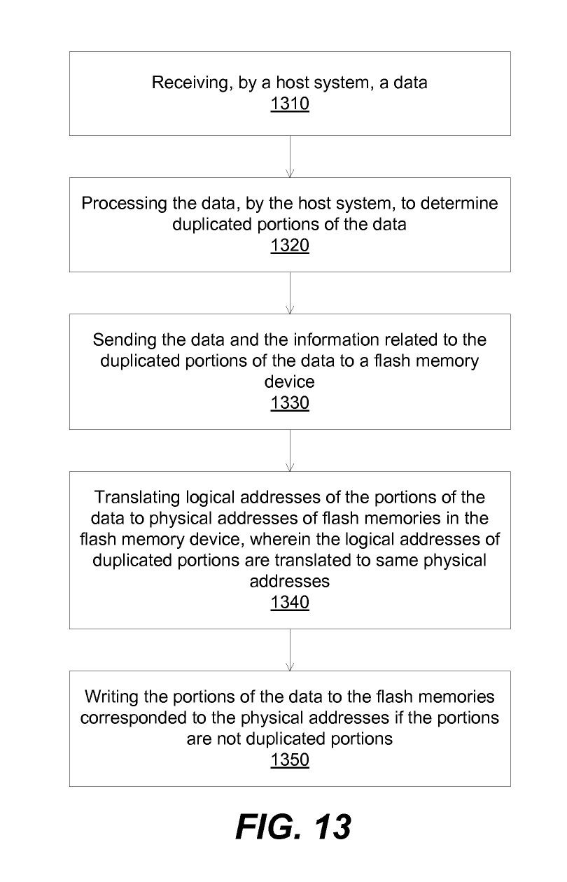

FIG. 13 illustrates a flow chart for storing data from a host system to a solid state drive according to some embodiments. Operation 1310 receives, by a host system, a data. Operation 1320 processes the data, by the host system, to determine duplicated portions of the data. Operation 1330 sends the data and the information related to the duplicated portions of the data to a flash memory device. Operation 1340 translates logical addresses of the portions of the data to physical addresses of flash memories in the flash memory device, wherein the logical addresses of duplicated portions are translated to same physical addresses. Operation 1350 writes the portions of the data to the flash memories corresponded to the physical addresses if the portions are not duplicated portions.

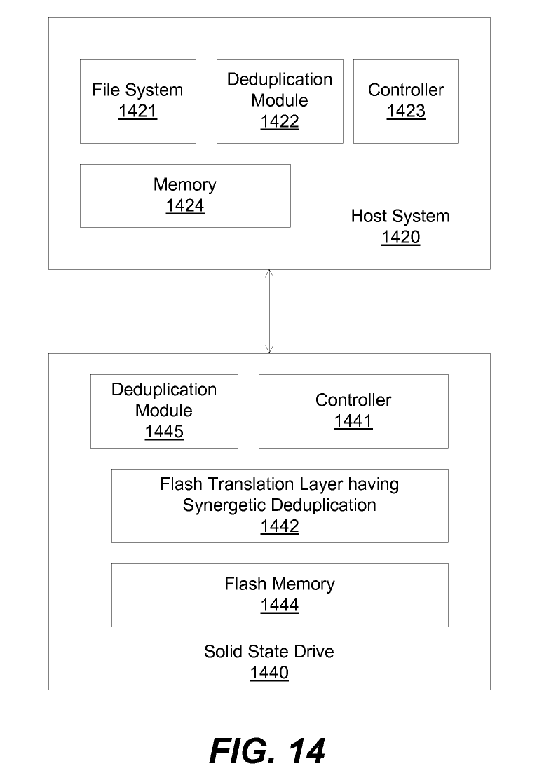

FIG. 14 illustrates a system for synergetic deduplication according to some embodiments. A solid state drive 1440 can have a memory component, such as flash memory 1444, a flash translation layer 1442 having synergetic deduplication, a deduplication module 1445 and a controller 1441. The flash translation layer 1442 can include software or firmware to generate or manage a synergetic deduplication mapping, which integrates logical-to-physical address mapping and deduplication mapping. The deduplication module 1445 can include deduplication algorithm for evaluating deduplicated portions of a data. The controller 1441 can be configured to perform other functions of the solid state drive, such as communication with a host system 1420, and other functions related to the flash memory management such as memory selection, wear leveling, garbage collection, etc.

The host system 1420 can include memory 1424, file system configuration 1421, deduplication module 1422, and controller 1423. The file system configuration 1421 can include features of accessible files, such as arrangements of memory. The controller 1423 can be used to run programs, which can uses memory 1424.

For example, the host system can have a data arranged according to the file system. The host system can store the data to the solid state drive. After receiving the data from the host system, the solid state drive can access the data to determine duplicated portions, and the data is written to memory without the duplicated portions.

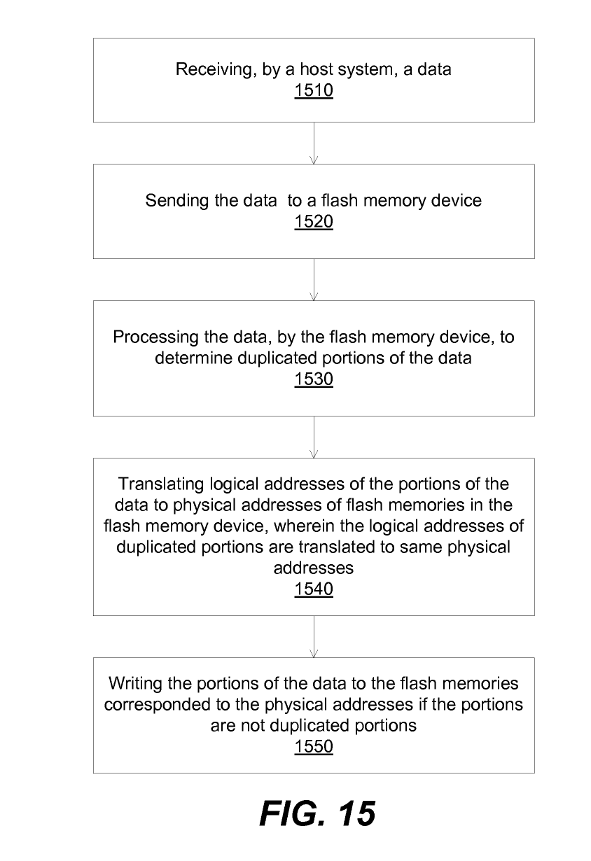

FIG. 15 illustrates a flow chart for storing data from a host system to a solid state drive according to some embodiments. Operation 1510 receives, by a host system, a data. Operation 1520 sent the data to a flash memory device. Operation 1530 processes the data, by the flash memory device, to determine duplicated portions of the data. Operation 1540 translates logical addresses of the portions of the data to physical addresses of flash memories in the flash memory device, wherein the logical addresses of duplicated portions are translated to same physical addresses. Operation 1550 writes the portions of the data to the flash memories corresponded to the physical addresses if the portions are not duplicated portions.

In some embodiments, provided is a machine readable storage, having stored there on a computer program having a plurality of code sections for causing a machine to perform the various steps and/or implement the components and/or structures disclosed herein. In some embodiments, the present invention may also be embodied in a machine or computer readable format, e.g., an appropriately programmed computer, a software program written in any of a variety of programming languages. The software program would be written to carry out various functional operations of the present invention. Moreover, a machine or computer readable format of the present invention may be embodied in a variety of program storage devices, such as a diskette, a hard disk, a CD, a DVD, a nonvolatile electronic memory, or the like. The software program may be run on a variety of devices, e.g. a processor.

In some embodiments, the methods can be realized in hardware, software, or a combination of hardware and software. The methods can be realized in a centralized fashion in a data processing system, such as a computer system or in a distributed fashion where different elements are spread across several interconnected computer systems. Any kind of computer system or other apparatus adapted for carrying out the methods described herein can be used. A typical combination of hardware and software can be a general-purpose computer system with a computer program that can control the computer system so that the computer system can perform the methods. The methods also can be embedded in a computer program product, which includes the features allowing the implementation of the methods, and which when loaded in a computer system, can perform the methods.

The terms “computer program”, “software”, “application”, variants and/or combinations thereof, in the context of the present specification, mean any expression, in any language, code or notation, of a set of instructions intended to cause a system having an information processing capability to perform a particular function either directly. The functions can include a conversion to another language, code or notation, or a reproduction in a different material form. For example, a computer program can include a subroutine, a function, a procedure, an object method, an object implementation, an executable application, an applet, a servlet, a source code, an object code, a shared library/dynamic load library and/or other sequence of instructions designed for execution on a data processing system, such as a computer.

In some embodiments, the methods can be implemented using a data processing system, such as a general purpose computer system. A general purpose computer system can include a graphical display monitor with a graphics screen for the display of graphical and textual information, a keyboard for textual entry of information, a mouse for the entry of graphical data, and a computer processor. In some embodiments, the computer processor can contain program code to implement the methods. Other devices, such as a light pen (not shown), can be substituted for the mouse. This general purpose computer may be one of the many types well known in the art, such as a mainframe computer, a minicomputer, a workstation, or a personal computer.

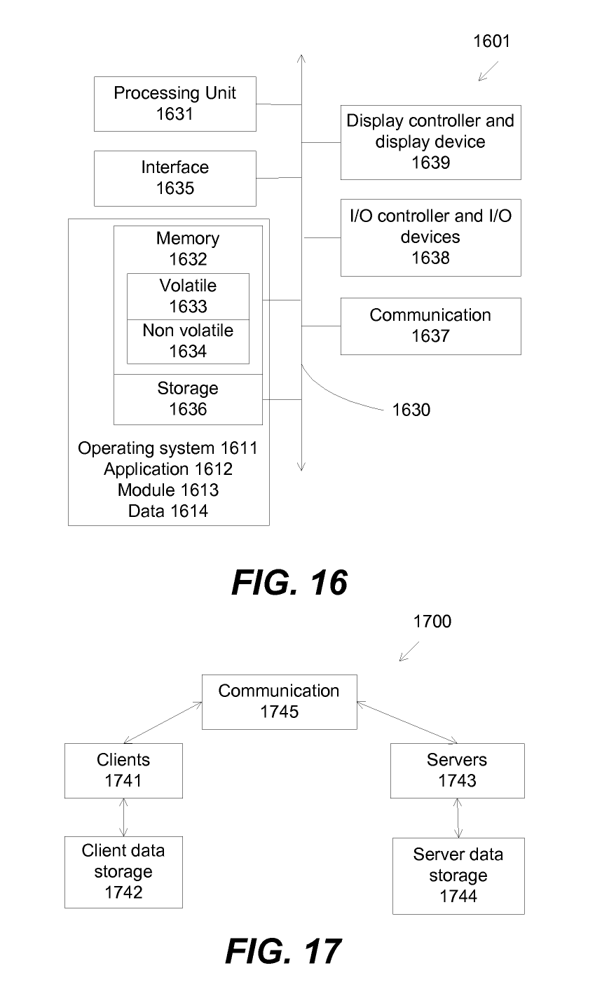

FIG. 16 illustrates a computing environment according to some embodiments. An exemplary environment for implementing various aspects of the invention includes a computer 1601, comprising a processing unit 1631, a system memory 1632, and a system bus 1630. The processing unit 1631 can be any of various available processors, such as single microprocessor, dual microprocessors or other multiprocessor architectures. The system bus 1630 can be any type of bus structures or architectures, such as 12-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), or Small Computer Systems Interface (SCST).

The system memory 1632 can include volatile memory 1633 and nonvolatile memory 1634. Nonvolatile memory 1634 can include read only memory (ROM), programmable ROM (PROM), electrically programmable ROM (EPROM), electrically erasable ROM (EEPROM), or flash memory. Volatile memory 1633, can include random access memory (RAM), synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), or direct Rambus RAM (DRRAM).

Computer 1601 also includes storage media 1636, such as removable/nonremovable, volatile/nonvolatile disk storage, magnetic disk drive, floppy disk drive, tape drive, Jaz drive, Zip drive, LS-100 drive, flash memory card, memory stick, optical disk drive such as a compact disk ROM device (CD-ROM), CD recordable drive (CD-R Drive), CD rewritable drive (CD-RW Drive) or a digital versatile disk ROM drive (DVD-ROM). A removable or non-removable interface 1635 can be used to facilitate connection. These storage devices can be considered as part of the I/O device 1638 or at least they can be connected via the bus 1630. Storage devices that are “on board” generally include EEPROM used to store the BIOS.

The computer system 1601 further can include software to operate in the environment, such as an operating system 1611, system applications 1612, program modules 1613 and program data 1614, which are stored either in system memory 1632 or on disk storage 1636. Various operating systems or combinations of operating systems can be used.

Input devices can be used to enter commands or data, and can include a pointing device such as a mouse, trackball, stylus, touch pad, keyboard, microphone, joystick, game pad, satellite dish, scanner, TV tuner card, sound card, digital camera, digital video camera, web camera, and the like, connected through interface ports 1638. Interface ports 1638 can include a serial port, a parallel port, a game port, a universal serial bus (USB), and a 1694 bus. The interface ports 1638 can also accommodate output devices. For example, a USB port may be used to provide input to computer 1601 and to output information from computer 1601 to an output device. Output adapter 1639, such as video or sound cards, is provided to connect to some output devices such as monitors, speakers, and printers.

Computer 1601 can operate in a networked environment with remote computers. The remote computers, including a memory storage device, can be a personal computer, a server, a router, a network PC, a workstation, a microprocessor based appliance, a peer device or other common network node and the like, and typically includes many or all of the elements described relative to computer 1601. Remote computers can be connected to computer 1601 through a network interface 1635 and communication connection 1637, with wire or wireless connections. Network interface 1635 can be communication networks such as local-area networks (LAN), wide area networks (WAN) or wireless connection networks. LAN technologies include Fiber Distributed Data Interface (FDDI), Copper Distributed Data Interface (CDDI), Ethernet/IEEE 1202.3, Token Ring/IEEE 1202.5 and the like. WAN technologies include, but are not limited to, point-to-point links, circuit switching networks like Integrated Services Digital Networks (ISDN) and variations thereon, packet switching networks, and Digital Subscriber Lines (DSL).

FIG. 17 is a schematic block diagram of a sample computing environment with which the present invention can interact. The system 1700 includes a plurality of client systems 1741. The system 1700 also includes a plurality of servers 1743. The servers 1743 can be used to employ the present invention. The system 1700 includes a communication network 1745 to facilitate communications between the clients 1741 and the servers 1743. Client data storage 1742, connected to client system 1741, can store information locally. Similarly, the server 1743 can include server data storages 1744.

Having thus described certain preferred embodiments of the present invention, it is to be understood that the invention defined by the appended claims is not to be limited by particular details set forth in the above description, as many apparent variations thereof are possible without departing from the spirit or scope thereof as hereinafter claimed.

What is claimed is

1. An address mapping table adapted for use with a solid state drive, the address mapping table comprising:
logical addresses of data, wherein the data is configured to be stored in memories of the solid state drive;
physical addresses of the memories,
wherein the address mapping table is configured to map the logical addresses to the physical addresses,
wherein the address mapping table is further configured to map logical addresses of duplicated portions of the data to same physical addresses of memories of the solid state drive.

2. An address mapping table as in claim 1
wherein the solid state drive comprises a flash memory device.

3. An address mapping table as in claim 1
wherein the logical addresses are logical page values in the flash memory,
wherein the physical addresses are physical page values in the flash memory.

4. An address mapping table as in claim 1
wherein the mapping of duplicated portions of data is controlled by a deduplication module.

5. An address mapping table as in claim 1
wherein the address mapping table comprises an integration of a flash translation mapping and a deduplication mapping.

6. An address mapping table as in claim 1
wherein the address mapping table is formed based on the data and based on information related to data duplication characteristics.

7. A solid state drive, the solid state drive comprising:
one or more memory modules;
a controller coupled to the one or more memory modules,
wherein the controller is operable to communicate with a host system for exchanging data between the solid state drive and the host system,
wherein the data is configured to be stored in memories of the one or more memory modules,
wherein the controller is operable to map logical addresses of the data to physical addresses of the memories of the one or more memory modules,
wherein the controller is further operable to map logical addresses of duplicated portions of the data to same physical addresses of the memories of the one or more memory modules.

8. A solid state drive as in claim 7
wherein the logical addresses are obtained from the host system.

9. A solid state drive as in claim 7
wherein the mapping of the controller comprises an integration of a flash translation mapping and a deduplication mapping.

10. A solid state drive as in claim 7
wherein the controller is configured to receive the data and information related to data duplication characteristics to perform the mapping.

11. A solid state drive as in claim 7
wherein the mapping from logical addresses to physical addresses by the controller is performed by a firmware.

12. A solid state drive as in claim 7 further comprising
a firmware in a flash translation layer, wherein the firmware is executed by the controller to perform the mapping from logical addresses to physical addresses.

13. A solid state drive as in claim 7
wherein the mapping from logical addresses to physical addresses is performed with inputs from a deduplication module, wherein the deduplication module is operable to identify duplicated data portions.

14. A solid state drive as in claim 7 further comprising
a deduplication module, wherein the deduplication module is operable to identify duplicated data portions to assist in the mapping.

15. A method for forming a solid state drive, the method comprising:
forming one or more memory modules;
forming a controller coupled to the one or more memory modules,
wherein the controller is operable to communicate with a host system for exchanging data between the solid state drive and the host system,
wherein the data is configured to be stored in memories of the one or more memory modules,
wherein the controller is operable to map logical addresses of the data to physical addresses of memories of the one or more memory modules,
wherein the controller is further operable to map logical addresses of duplicated portions of the data to same physical addresses of the memories of the one or more memory modules.

16. A method as in claim 15 further comprising
installing a firmware to the solid state drive, wherein the firmware is operable to control the mapping from logical addresses of the data to physical addresses.

17. A method as in claim 15
wherein the mapping of the controller comprises an integration of a flash translation mapping and a deduplication mapping.

18. A method as in claim 15
wherein the mapping from logical addresses to physical addresses by the controller is performed by a firmware.

19. A method as in claim 15
wherein the mapping from logical addresses to physical addresses is performed with inputs from a deduplication module from the host system, wherein the deduplication module is operable to identify duplicated data portions.

20. A method as in claim 15
wherein the mapping from logical addresses to physical addresses is performed by the controller, wherein the controller is configured to perform comparison of data portions to identify duplicated data portions to assist in the mapping.
